(19) United States
(12) Patent Application Publication
(10) Pub. No.: US 2016/0363157 A1
(43) Pub. Date: Dec. 15, 2016

(54) Connection System, Clamping Screw, Method For Connecting Two Components And Tool For Producing The Connection System

(71) Applicant: Airbus Operations GmbH, Hamburg (DE)

(72) Inventor: Thomas Sobotta, Hamburg (DE)

(73) Assignee: Airbus Operations GmbH, Hamburg (DE)

(21) Appl. No.: 15/177,438

(22) Filed: Jun. 9, 2016

(30) Foreign Application Priority Data
Jun. 11, 2015 (DE) 10 2015 109 278.6

(51) Int. Cl. F16B 39/284; F16B 41/00; F16B 37/00; B25B 15/00; B25B 23/14

(52) U.S. Cl. CPC F16B 39/284; B25B 15/008; B25B 23/14; F16B 37/00; F16B 41/002

(57) ABSTRACT

A connection system for connecting two components, particularly two components of an aircraft, by a threaded joint, includes a clamping screw locked with a nut. A clamping screw for use in such a connection system and a method for connecting two components are also described. The clamping screw includes an axial borehole with an internal thread to receive a securing pin, an external thread for connection to the nut and a counter bearing for locking the nut. The clamping screw is designed such that is elastically deformable in the radially inward direction in the area of the counter bearing, and in this area has a greater radial extension than in the remaining area of the clamping screw.

### FIELD OF THE INVENTION

The invention relates to a connection system for connecting two adjacent components, particularly two components of an aircraft, via a threaded joint, wherein a screw is locked with a nut, so that the components are braced against each other. The invention further relates to a clamping screw for use in such a connection system, a method for connecting two adjacent components, and a combination tool for producing the connection system.

### BACKGROUND OF THE INVENTION

The most frequently performed activity when installing systems in an aircraft is fitting threaded joints. It is not unusual to fit as many as 37,000 threaded joints per aircraft. The total fitting time involved for each aircraft is quite significant.

In many such threaded joints, one side of the components to be joined is ergonomically readily accessible to enable the screw to be positioned and secured. However, the other side of the components to be joined, which is normally used for placing the nut as the counterpart, is often difficult to access.

### BRIEF SUMMARY OF THE INVENTION

An aspect of the present invention may provide a particularly secure connection system, a clamping screw and a method of the kid described in the introduction, which can be assembled easily from one side.

The present invention provides a way to connect two or more components by a threaded joint from just one side of the two components to be connected particularly easily and securely. It is not necessary to position and fit one part of the threaded joint, such as a nut, or to use a tool from the other side of the components to be connected. Additionally, a particularly secure threaded joint is assured by the provision of a securing pin inside a clamping screw.

The connection system according to an embodiment of the invention comprises a clamping screw, a securing pin and a nut. The clamping screw has an axial borehole with an internal thread for receiving the securing pin, an external thread for connecting to the nut, and a counter bearing for locking the nut. The clamping screw is designed so that it can be elastically deformed radially inwardly in the area of the counter bearing.

The external thread and the counter bearing are arranged on the clamping screw in such manner that the nut can be locked against the counter bearing. The nut and the counter bearing may be located on two opposite axial ends of the clamping screw. The clamping screw further has a radially outwardly protruding shoulder in the area of the counter bearing, that is to say, in this area the radial extension is greater that in the area of the rest of the clamping screw. The counter bearing of the clamping screw may be in the form of at least one clip, which may be positioned flush with one of the components to be connected and then serves as the counter bearing for locking the nut.

The clamping screw has a tubular bolt, which is provided to be inserted into borehole in components that are to be connected, and to be inserted under pressure, the respective internal radii of the boreholes being smaller than the radial extension of the clamping screw in the area of the associated counter bearing. Thus, the counter bearing would actually prevent the clamping screw from being inserted in the boreholes of the parts that are to be connected. However, since the clamping screw is designed to be elastically deformable in the inwardly radial direction in the area of the counter bearing, the clamping screw can be introduced into the boreholes. In order to carry out the insertion, it is necessary for an axial force to be applied to the clamping screw in the direction of the boreholes of the components to be connected, thereby causing the clamping screw to be deformed in the area of the counter bearing during insertion in such manner that the radial extension of the counter bearing is equal to the internal radius of the boreholes, or no longer greater than the internal radius of the boreholes. Consequently, the clamping screw with its counter bearing passes through the borehole in the components to be connected. In this way, it is possible for the clamping screw to be inserted in the boreholes of the components to be connected.

In order to enable the counter bearing to be brought flush with a first of the components to be connected, it is necessary for the radial extension of the counter bearing to become greater than the internal radius of the boreholes of the components to be connected again after the clamping screw has been elastically deformed radially inwardly, and inserted in the boreholes. For this purpose, the clamping screw has resilient properties at least in the area of the counter bearing, thus enabling an elastic recovery. In other words, the clamping screw is designed to be elastically deformed in a radially inward direction in the area of the counter bearing, and to spring back radially outwardly into its original shape and dimension after such a deformation.

The nut may be screwed onto the external thread and brought flush with a second of the components to be connected. In this way, the nut may be locked against the counter bearing. Accordingly, the components may be clamped with respect to each other by the application of a predetermined torque, wherein a corresponding clamping force acts vertically on the contacting surfaces of the clamped components. This prevents the components from coming loose and being lost. At the same, a clamping force acting on a surface of the boreholes may be dispensed with.

The significance of the securing pin that is screwed into the boreholes in the clamping screw is that it makes it possible to prevent the clamping screw from being inadvertently deformed radially inwardly in the area of the counter bearing again, so that it is no longer flush with the component in question. The securing pin has an external thread that matches the internal thread of the clamping screw, so the axial position of the securing pin inside the borehole of the clamping screw may be secured and particularly well monitored. Alternatively, the securing pin may also be secured with retaining means such as clips inside the clamping screw, wherein in this case there is no longer a need for an internal thread inside the clamping screw. The securing pin thus helps to ensure a particularly secure connection between the components to be connected. The securing pin may also have a hexagonal cutout, into which a hexagon wrench may be inserted to turn the securing pin into the clamping screw. Alternatively, the securing pin may also have a screw head, for example, for the same purpose.

The clamping screw may further be flattened on two sides at the ends thereof, particularly in the area around the internal thread, so that an open-ended wrench may be inserted to prevent the clamping screw from being turned. This may be useful if the clamping screw exhibits a tendency to turn while the nut is being finally locked and the securing pin is to be screwed into the clamping screw.

According to one variant, the internal thread and the external thread pass round the clamping screw in opposite directions. For example, the internal thread may be a right-hand thread and the external thread may be a left-hand thread, or vice versa. The opposite threads make it possible for the nut to be locked against the counter bearing and the securing pin to be screwed into the clamping screw without the locked nut having to be turned beforehand.

According to a further variant, it is provided that the axial borehole connects opposing frontal faces of the clamping screw to each other. In other words, the axial borehole passes completely through the clamping screw, which is consequently open on both sides. This is a particularly simple way to enable the clamping screw to be constructed such that it is elastically deformable in a radially inward direction and can recover its original shape resiliently in the area of the counter bearing.

In an example, the counter bearing of the clamping screw particularly includes a plurality of arrow-shaped pins. The outer ends of the arrows are bevelled, that is to say they extend at a converging angle with the lengthwise axis of the clamping screw. In this way, an insertion force acting axially on the counter bearing of the clamping screw exerts a radial deforming force, causing the counter bearing to be deformed radially inwards. This variant helps to make it easier for the clamping screw to be inserted in the boreholes of the components to be connected.

According to a further variant, the clamping screw has at least one temporary stop element, in the form of a predetermined breaking point. The temporary stop may be designed to break when a specified torque for locking the nut is exceeded. The temporary stop may be useful when a combination tool—also according to the invention—is used to fix the nut and the securing pin in place. Such a combination tool comprises two parts, an Allen key for the securing pin and a torque wrench arranged to surround the Allen key for the nut, wherein the two parts are designed to be able to rotate in different directions.

The temporary stop may be arranged inside the borehole of the clamping screw, in particular between the internal thread and the counter bearing. In this position, it serves as a stop element for the securing pin, which can be screwed into the internal thread by the Allen key of the aforementioned combination tool by the end face of the clamping screw opposite the counter bearing for example. When the securing pin has been screwed far enough into the internal thread of the clamping screw so that the securing pin is flush with the temporary stop element, a surface friction for example or positive locking arrangement between the securing pin and the stop element create a torque-dependent resistance to further turning of the securing pin and the Allen key of the combination tool. If at the same time the nut is being screwed onto the external thread of the clamping screw by the combination tool torque wrench but is not yet in a position flush with one of the components to be connected, a turning of the securing pin and the Allen key which would be undesirable at this point can be prevented by said turning resistance. This condition still persists when the nut is flush with one of the components to be connected, the counter bearing is flush with an other component on the other side of the component, and a locking torque, with which the nut is locked against the counter bearing, is not yet sufficient to overcome the turning resistance. The Allen key does not begin turning again until the locking torque is greater than the turning resistance, at which point the torque wrench stops turning. The rotation of the Allen key causes the securing pin to be rotated past the temporary stop element, which consequently breaks and leaves the way clear for the securing pin to be screwed in farther.

The torque required to overcome the turning resistance and cause the temporary stop element to break is chosen low enough, and a clamping force between the nut and the clamping screw is chosen high enough (contingent on the torque rating of the nut) to prevent the clamping screw from turning with the securing pin.

Alternatively, the temporary stop element may also be arranged on the outer circumference of the clamping screw, particularly in the area of the external thread. When the connection system is assembled using the combination tool described previously, the temporary stop element may create a turning resistance for the nut of the connection system and the torque wrench of the combination tool in keeping with the notes in the preceding text. When the securing pin has reached its intended final position (defined for example by an element referred to in the following as a limit stop), the turning resistance can be overcome, so that the torque wrench and the nut both turn, the temporary stop element breaks, and the nut can be locked against the counter bearing with an intended torque.

The clamping screw may further have at least one limit stop for the securing pin that indicates that the securing pin has been screwed optimally into the clamping screw, and prevents the securing pin from being screwed in farther. The limit stop may be useful when used in conjunction with the aforementioned combination tool. For example, the limit stop may be arranged in the area of the counter bearing. Alternatively, it may also be provided that the limit stop is not formed by the clamping screw, but by the securing pin instead. In this case, it may be provided that the securing pin has a collar that may be brought into a position flush with the nut and thus prevents the securing pin from being screwed farther into the clamping screw.

The clamping screw for the clamped connection of two adjacent components comprises an axial borehole with an internal thread for receiving the securing pin, an external thread for connecting to the nut, and a counter bearing for locking the nut. The clamping screw has a larger radial extension in the area of the counter bearing than in the remaining area of the clamping screw, and is designed to be elastically deformed radially inwardly in the area of the counter bearing. Regarding the advantages and variants of the clamping screw, reference is herewith made to the explanation relating to the connection system in order to avoid repetitions.

According to a method for connecting two components, a clamping screw, a securing pin and a nut are provided—all three of which elements have been described in the preceding text in the context of the connection system and/or the clamping screw. The clamping screw is inserted into aligned boreholes in the components from one side in such manner that a counter bearing of the clamping screw is deformed radially inwards and then regains its former shape as soon as it emerges on the other side of the components. Then the nut is locked against the stop element with a predetermined torque and the securing pin is screwed into an internal thread of the clamping screw.

If a temporary stop element as described previously is provided in the area of the borehole in the clamping screw, the method may be carried out in the sequence of method steps described. But if a temporary stop element as described previously is provided in the area of the outer circumference of the clamping screw, the order in which the last two method steps are carried out is reversed, that is to say, after a clamping screw, a securing pin and a nut have been provided, the securing pin is screwed into the internal thread of the clamping screw as far as a predetermined position, and then the nut is locked against the stop element with a predetermined torque.

In this context, the securing pin may be screwed in as far as a limit stop for the securing pin.

According to a further variant of the method, it is provided that the clamping screw, the securing pin and the nut are preassembled. The securing pin is already screwed a short distance into the internal thread of the clamping screw, for example, just as far as a possibly present temporary stop element. The nut is screwed a short distance onto the external thread of the clamping screw, for example, just far enough to leave a sufficient length of the thread free in the direction of the counter bearing to enable the nut to be locked when the clamping screw is subsequently inserted in boreholes of two components to be connected, and the counter bearing is brought into a position flush with one of the components to be connected. This makes it easier to insert the clamping screw and prevents the clamping screw from falling off on the rear side of the component.

Regarding further advantages and variants of the method according to the invention, reference is herewith made to the explanation relating to the connection system according to the invention and the following description of the figures in order to avoid repetitions.

The combination tool according to an embodiment of the invention for fixing a nut and a securing pin of a connection system according to the invention as described in the preceding text comprises an Allen key for turning the securing pin and a torque wrench arranged around the outside of the Allen key for turning the nut. The Allen key and the torque wrench are designed so that they rotate in opposite directions.

### BRIEF DESCRIPTION OF THE DRAWINGS

In the following, embodiments of the invention will be explained in greater detail with reference to the drawing, wherein for the sake of improved clarity identical or similar elements are not identified with reference signs in all figures. In the drawing:

FIG. 1 shows a partially cutaway exploded view of an example of a connection system with an example of a clamping screw,

FIG. 2 is a process flowchart of an example of a method,

FIG. 3 shows the connection system provided in the preassembled state,

FIGS. 4-8 show the connection system of FIG. 3 at various times while the method of FIG. 2 is being carried out,

FIG. 9 is a perspective view of a combination tool according to an example for use in the method of FIG. 2,

FIG. 10 is a perspective view of a further variant of a connection system with a clamping screw having an end piece flattened on two sides, and

FIG. 11 is a side view of the connection system of FIG. 10.

### DETAILED DESCRIPTION

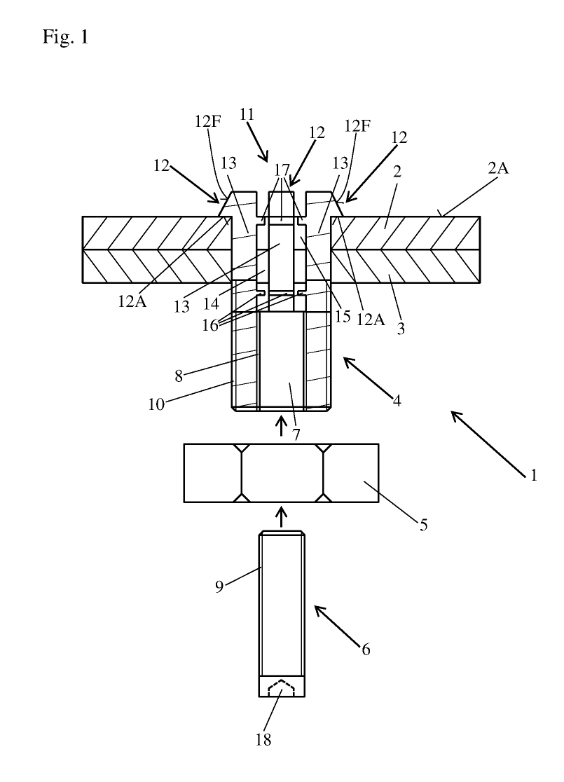

FIG. 1 shows a connection system 1 for clamped connection of two adjacent components 2 and 3, wherein in the following the component shown at top in FIG. 1 is referred to as upper component 2 and the component shown at bottom in FIG. 1 is referred to as lower component 3. Connection system 1 comprises a clamping screw 4, a nut in the form of a locknut 5 and a securing pin 6.

Clamping screw 4 shown in partial cutaway view has a through borehole 7, which extends in the axial direction of clamping screw 4 and is furnished with an internal thread 8. Securing pin 6 has an external thread 9 that matches internal thread 8. In addition, clamping screw 4 also has an external thread 10, which matches an internal thread on locknut 5 (not shown). Internal thread 8 of clamping screw 4 is a right-hand thread, external thread 10 in clamping screw 4 is a left-hand thread.

A counter bearing in the form of four clips 12 is arranged on an outer axial end 11 of clamping screw 4 in order to lock locknut 5, the clips 12 being in the form of four arrow-shaped pins 13, only three of which are visible in FIG. 1 due to the cutaway representation. Clips 12 form a bearing surface 12A that extends radially outwards, and which in the configuration shown in FIG. 1 lies flush with a surface 2A of upper component 2. Each of the clips 12 has a bevel 12F that extends circumferentially and converges towards the outer end thereof, which facilitates the insertion of clamping screw 4 together with its clips 12 in two aligned boreholes 14 and 15 of components 2 and 3.

Clamping screw 4 has a greater radial extension in the area of clips 12 than in the remaining area of clamping screw 4, and is designed to be elastically deformed in a radially inward direction in the area of clips 12. Clamping screw 4 further has temporary stop elements 16 for securing pin 6 arranged at the same axial level and behind internal thread 8 in the area of the respective borehole 7 thereof, which are constructed as predetermined breaking points. Clamping screw 4 further has three limit stops arranged 17 arranged at the same axial level for securing pin 6. Securing pin 6 has a hexagonal cutout 18 on the end face thereof, into which an Allen key (FIG. 8) may be inserted to screw securing pin 6 into clamping screw 4.

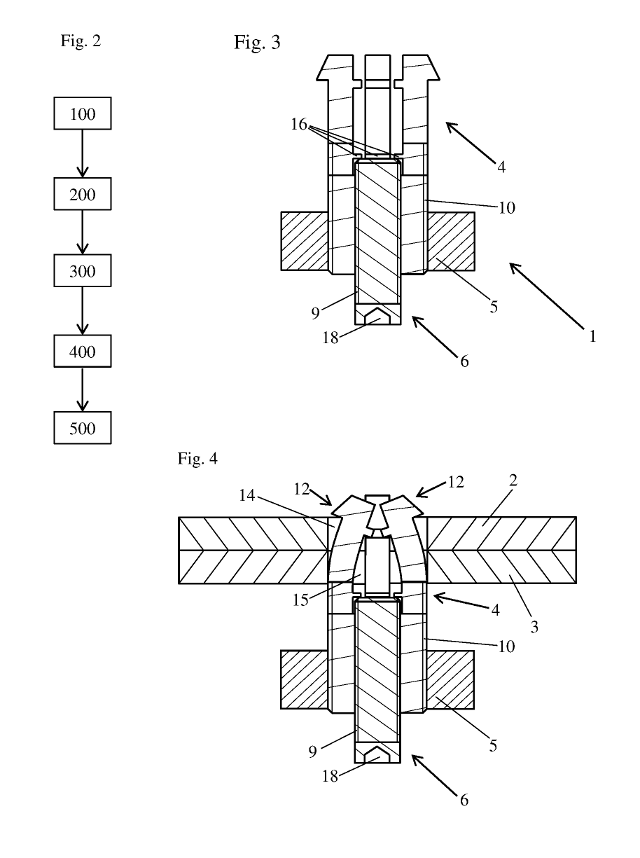

In order to clamp and thus secure adjacent components 2 and 3 together according to an embodiment of the method represented in FIG. 2, in a first method step 100 the clamping screw 4, locknut 5 and securing pin 6 shown in FIG. 1 are provided. They are provided—as shown in FIG. 3—in a preassembled state, that is to say locknut 5 is already screwed a small distance onto external thread 10 of clamping screw 4, and securing pin 6 is already screwed into internal thread 8 of clamping screw 4 as far as temporary stop element 16.

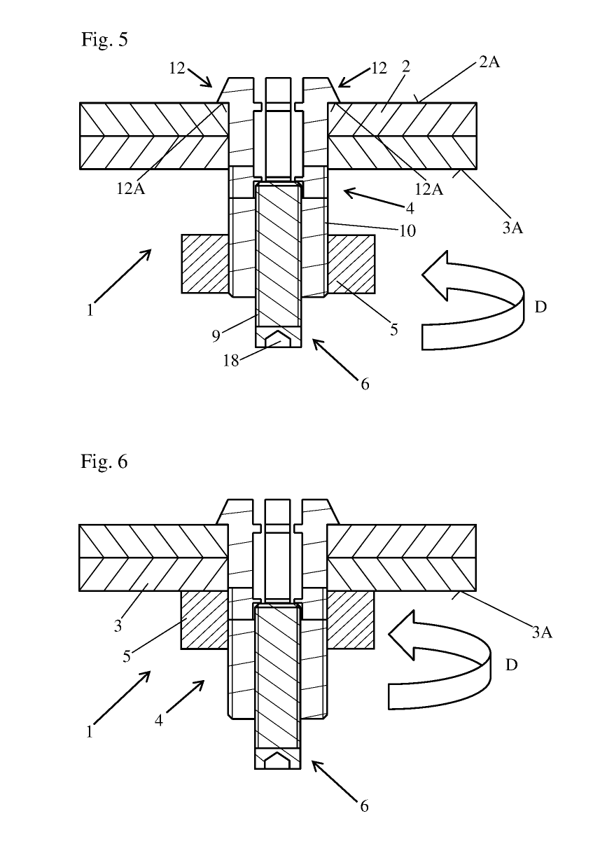

In a second method step 200 (FIGS. 4 and 5) clamping screw 4 with its clips 12 is inserted into the aligned boreholes 14 and 15 inside components 2 and 3 from the side of lower component 3, in such manner that the clips 12 are elastically deformed radially inwardly and regain their original shape resiliently as soon as they emerge on the side of upper component 2 (FIG. 4). After regaining their shape, bearing surfaces 12A of clips 12 are positioned flush with surface 2A of upper component 2 (FIG. 5).

Then, in a third method step 300 locknut 5 is rotated in the direction of double-headed arrow D in FIG. 5 until it lies flush with a surface 3A of lower component 3 (FIG. 6). Then, locknut 5 is locked with a predetermined torque against clips 12 by turning further in the direction of double-headed arrow D.

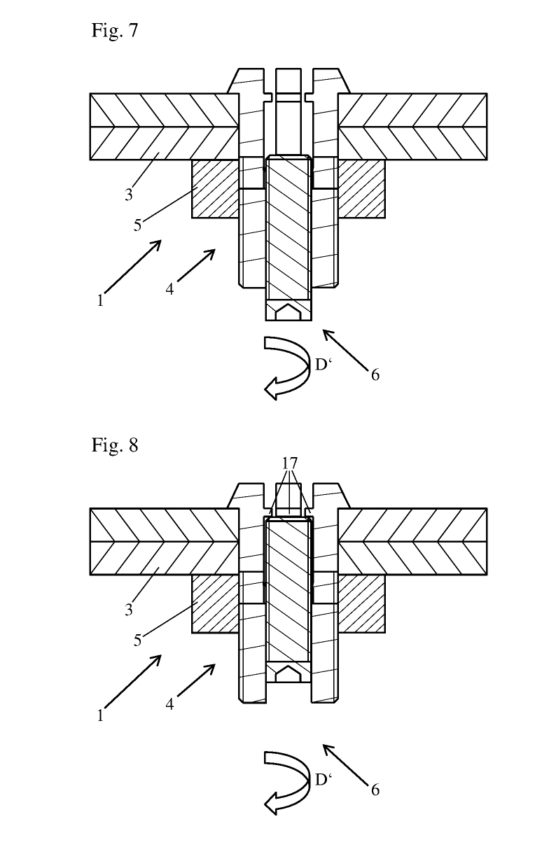

Then, in a fourth method step 400 (FIG. 7), securing pin 6 is screwed farther into internal thread 8 of clamping screw 4 in the direction of double-headed arrow D′, wherein securing pin 6 is screwed in axially beyond the temporary stop element 16, causing temporary stop elements 16 to break. In FIG. 7, the stop elements 16 are already broken off.

Then, in a fifth method step 500 (FIG. 8) securing pin 6 is screwed farther in the direction of double-headed arrow D′ until the upper end face of securing pin 6 touches limit stops 17.

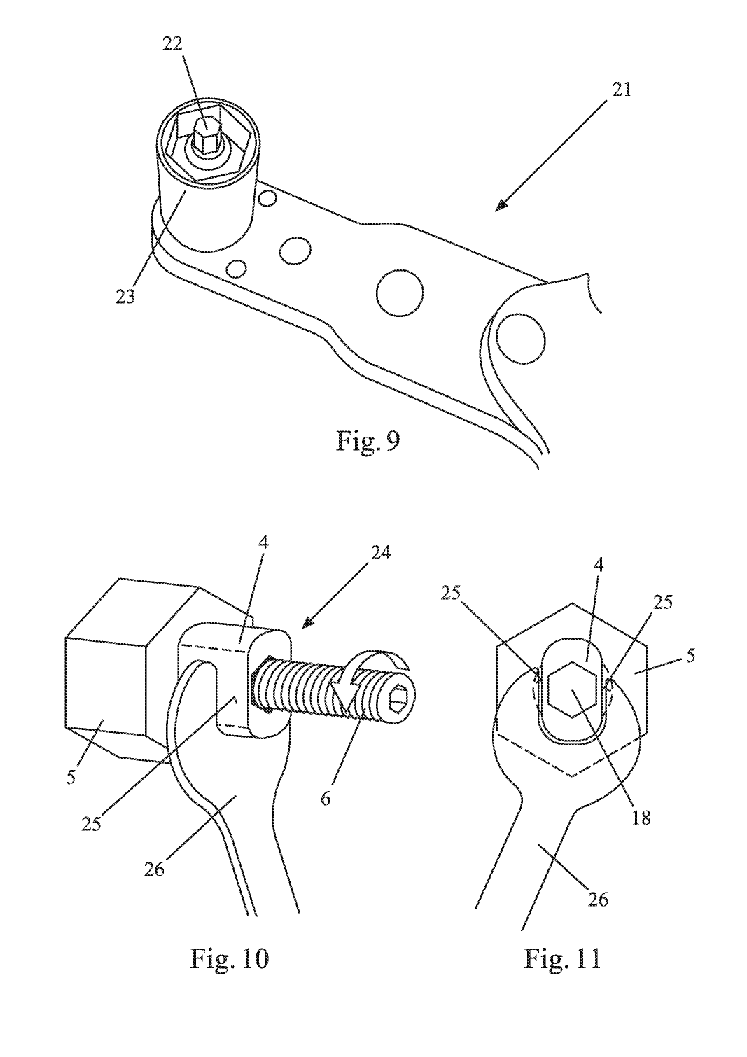

In order to lock locknut 5 and screw in securing pin 6, a combination tool 21 according to FIG. 9 may be used, which tool comprises two elements, an Allen key 22 for securing pin 6 and a torque wrench 23 arranged around the outside of Allen key 22, for locknut 5, wherein the elements 22 and 23 are designed to turn in different directions.

With the aid of the Allen key 22 of combination tool 21, securing pin 6 is screwed into internal thread 8 of clamping screw 4, wherein Allen key 22 engages in the hexagonal cutout 18 in securing pin 6. When securing pin 6 has been screwed into internal thread 8 of clamping screw 4 far enough for securing pin 6 to lie against temporary stop elements 16 (see FIG. 3), a surface friction between securing pin 6 and stop elements 16 may create a torque-dependent turning resistance to further rotation of securing pin 6 and Allen key 22 of combination tool 21. At the same time, locknut 5 is screwed onto external thread 10 of clamping screw 4 by torque wrench 23 of combination tools 21 (see FIG. 5). While locknut 5 does not yet lie flush against lower component 3, a rotation of securing pin 6 and Allen key 22, which would be undesirable at this time, is prevented by said turning resistance. This state also persists when locknut 5 lies flush against component 3, clips 17 lies flush with the other component 2 on the other side, and a locking torque, with which locknut 5 is locked against clips 17, is not yet strong enough to overcome the turning resistance (see FIG. 6).

Allen key 22 does not begin to turn again until the locking torque is greater than the turning resistance, at which time torque wrench 23 stops turning. The rotation of Allen key 22 causes the end face of securing pin 6 closest to clips 17 to turn past temporary stop elements 16, which are broken thereby and leave the way unobstructed for screwing securing pin 6 in farther (see FIG. 7).

In order to prevent clamping screw 4 from turning with securing pin 6, the turning torque required is chosen low enough to overcome the turning resistance and break the temporary stop elements 16, while a clamping force between locknut 5 and clamping screw 4 (contingent on the torque rating of locknut 5) is chosen high enough.

FIGS. 10 and 11 show a part of a clamping screw 4, a locknut 5 and a securing pin 6 in another configuration. An axial end area 24 of clamping screw 4 has two planar flat sections 25, which are designed to fit an open-ended wrench 26, of which a part is shown. Engaging an open-ended wrench 26 and bracing it firmly is a particularly effective way to prevent clamping screw 4 from turning while locknut 5 is locked against clips 12 locked and securing pin 6 is screwed into clamping screw 4.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A connection system for clamped connection of at least two adjacent components comprising:
a clamping screw;
a securing pin; and
a nut,
wherein the clamping screw
comprises an axial borehole with an internal thread to receive the securing pin,
comprises an external thread for connection with the nut,
comprises at least one counter bearing for a locking of the nut,
comprises a larger radial extension in the area of the counter bearing than in the rest of the area of the clamping screw, and
is configured to be elastically deformed in a radially inward direction in the area of the counter bearing.

2. The connection system according to claim 1, wherein the internal thread and the external thread of the clamping screw extend in opposite directions.

3. The connection system according to claim 1, wherein the axial borehole connects opposite end faces of the clamping screw to each other.

4. The connection system according to claim 1, wherein the counter bearing of the clamping screw comprises a plurality of arrow-shaped pins.

5. The connection system according to claim 1, wherein the clamping screw has at least one temporary stop element, constructed as a predetermined breaking point.

6. The connection system according to claim 5, wherein the temporary stop element is configured to break when a specified torque for locking the nut is exceeded.

7. The connection system according to claim 1, wherein the clamping screw has at least one limit end stop for the securing pin.

8. A clamping screw for clamped connection of two adjacent components, comprising:
an axial borehole with an internal thread for receiving a securing pin;
an external thread for connection with a nut; and
a counter bearing for locking the nut,
wherein the clamping screw has a greater radial extension in the area of the counter bearing than in the remaining area of the clamping screw, and is configured to be elastically deformable in a radially inward direction in the area of the counter bearing.

9. A method for clamped connection of two adjacent components, the method comprising:
providing a clamping screw, a securing pin and a nut;
wherein the clamping screw
comprises an axial borehole with an internal thread to receive the securing pin,
comprises an external thread for connection with the nut,
comprises at least one counter bearing for a locking of the nut,
comprises a larger radial extension in the area of the counter bearing than in the rest of the area of the clamping screw, and
is configured to be elastically deformed in a radially inward direction in the area of the counter bearing,
inserting the clamping screw in aligned boreholes of the components from one side in such manner that a counter bearing of the clamping screw is elastically deformed in a radially inward direction and regains its shape resiliently as soon as the counter bearing emerges on the other side of the components;
locking the nut against the stop element with a predetermined torque; and
screwing the securing pin into an internal thread on the clamping screw.

10. The method according to claim 9, further comprising turning the securing pin as far as a limit stop for the securing pin.

11. The method according to claim 9, wherein the clamping screw, the securing pin and the nut are preassembled.

12. A combination tool for fixing a nut and a securing pin of a connection system for clamped connection of at least two adjacent components comprising:
a clamping screw;
a securing pin; and
a nut,
wherein the clamping screw
comprises an axial borehole with an internal thread to receive the securing pin,
comprises an external thread for connection with the nut,
comprises at least one counter bearing for a locking of the nut,
comprises a larger radial extension in the area of the counter bearing than in the rest of the area of the clamping screw, and
is configured to be elastically deformed in a radially inward direction in the area of the counter bearing; and
the tool further comprising an Allen key for turning the securing pin and a torque wrench arranged around the outside of the Allen key for turning the nut, wherein the Allen key and the torque wrench are configured to turn in different directions.
